(19) United States
(12) Patent Application Publication
(10) Pub. No.: US 2015/0299514 A1
(43) Pub. Date: Oct. 22, 2015

(54) INDUSTRIAL TOOLS WITH THERMOSET COATING

(71) Applicant: Varel International Ind., L.P., Carrollton, TX (US)

(72) Inventors: Cheng-Wei Chiu, McKinney, TX (US); David Michel Harrington, Dallas, TX (US)

(21) Appl. No.: 14/688,530

(22) Filed: Apr. 16, 2015

Related U.S. Application Data
(60) Provisional application No. 61/980,455, filed on Apr. 16, 2014.

(51) Int. Cl. C09D 183/04; C09D 175/04; C09D 163/00; C09D 161/28; C23C 4/12; C09D 163/04; C09D 179/08; C09D 167/00; C09D 119/00; C09D 175/02; C09D 171/00

(52) U.S. Cl. CPC C09D 183/04; C09D 175/02; C09D 175/04; C09D 163/00; C09D 161/28; C09D 171/00; C09D 163/04; C09D 179/085; C09D 167/00; C09D 119/003; C23C 4/12

(57) ABSTRACT

A method for applying a coating to a surface of an industrial tool includes applying a coating including a thermosetting polymer to a metallic surface of the industrial tool. The coating is cured to form a bond between the coating and the metallic surface. According to certain embodiments, the thermosetting polymer may be combined with an additive. The additive may be selected to improve the chemical resistance or wear resistance of the coating and thereby improve the chemical resistance or wear resistance of certain surfaces of the industrial tool.

### PRIORITY CLAIM

This application claims priority to U.S. Provisional Application for Patent Ser. No. 61/980,455, filed on Apr. 16, 2014, and entitled “Industrial Tools With Thermoset Coating,” the disclosure of which is hereby incorporated by reference.

### TECHNICAL FIELD

The present invention relates generally to industrial tools, such as earth boring bits and other tools associated with drilling and maintaining serviceability of a wellbore, and more particularly to applying a thermoset coating to such tools to improve surface properties, such as resistance to mechanical and chemical wear.

### BACKGROUND

Rock drill bits (both rolling cone and fixed cutter; such as PDC, down-the-hole (“DTH”), and the like are used to drill holes in the earth. The rock bit includes a family of cutting elements (also referred to as cutting structure). Examples of these cutting elements include tungsten carbide insert (TCI) teeth, Polycrystalline diamond compact (PDC) cutters, and the like. These cutting elements are held in precise locations by drilling holes or milling pockets in a surrounding body. For rolling cone bits, this is a steel cone. For drag bits (also known as fixed cuter bits or PDC drill bits), this is a steel or matrix body, for Down-the-Hole (“DTH” or “Hammer”) bits, this is a steel body. During drilling, the rock bit is likely to encounter multiple rock formations spanning a range of rock properties. The design of the drill bit cutting structure is a balance of durability for the harder formations, and aggressive cutting action for the softer, more drillable, formations.

As drillers continuously drill for longer time periods and greater penetration distances drilled out of rock bit, the disparity in rock formations encountered increases. That is, there is greater dissimilarity between the rock formations. This has resulted in the drill bits being designed for the hardest rock anticipated and being progressively less appropriate to the softer formations encountered. This misapplication of rock to rock bit cutting structure has detrimental effects on rock bit performance.

One common problem encountered is wear of the body surrounding the cutting elements. As the body in the vicinity of a cutting element wears, the retention of the TCI tooth or PDC cutter is reduced and can lead to loss of these cutting elements and reduced operational life of rock bit.

To combat this wear, several techniques have been tried with varying success. One method is to weld a hardfacing material on the body. For example, U.S. patent application Ser. No. 14/107,952 filed on Dec. 16, 2013, which is hereby incorporated by reference, discloses application of hardfacing using a plasma arc welding process. It has been found that it is difficult to apply hardfacing material in close proximity to the TCI tooth or cutter pocket. Another common solution is to apply a wear resistant spray coating by high velocity oxygen fuel (“HVOF”) or similar process. While this process is effective in covering more surfaces of the body, it requires expensive equipment, is loud (requiring special OSHA sound dampening), and can require parts to be sent from the jobsite to a remote location for processing.

Reference is made to U.S. Pat. No. 8,574,667 to John et al., which is hereby incorporated by reference and discloses a heated spray application of a powder composition including a thermoplastic polymer and a filler material to surfaces of a wellbore tool.

Reference is made to U.S. Pat. No. 5,609,286 to Anthon, which is hereby incorporated by reference and discloses employing a brazing rod to deposit an abrasive metal coating including diamond particles on a metal substrate. The brazing rod is heated by a flame until the braze material melts and is deposited as a liquefied material onto a metal substrate.

Reference is made to U.S. Pat. No. 7,487,840 to Gammage et al., which is hereby incorporated by reference and discloses using a thermal spraying process in combination with an iron based alloy to downhole equipment. The material includes tubular wires that, when deposited by a twin wire thermal spray process, result in the formation of a coating alloy whose structure is made up of a carbon/boron/chromium steel matrix containing precipitates of both chromium carbides and borides, and can include additional alloying elements acting as matrix strengtheners, such as nickel, molybdenum, tungsten, and titanium.

Reference is also made to U.S. Patent Application Publication No. 2013/0025941 by of Kumar, et al., which is hereby incorporated by reference and discloses a coating for a wellbore tool, which may be a polymer, a metal, or a combination thereof. The polymer may be an epoxy, a resin, or a thermoplastic. The coating is applied over a pattern of features formed on the body of the wellbore tool.

### SUMMARY

In an embodiment, a method for applying a coating to a surface of an industrial tool includes applying a coating including a thermosetting polymer (also referred to as a thermoset) to a metallic surface of the industrial tool. The coating is cured to form a bond between the coating and the metallic surface. According to certain embodiments, the thermosetting polymer may be combined with an additive. The additive may be selected to improve the chemical resistance or wear resistance of the coating and thereby improve the chemical resistance or wear resistance of certain surfaces of the industrial tool.

The present disclosure provides a number of advantages to improve performance. One advantage is extension of bit life due to reduction in body wear. This has application into many drilling operations in both oil and gas and open pit mining where large differences in formation properties are encountered, where the ability to remove cuttings from the bore hole are limited, or where the formation drilled is highly abrasive.

Another advantage is flexibility for ease of product refurbishment. Many products are periodically refurbished between uses. The current processes (e.g. welding, HVOF spray) can detrimentally affect the heat treated properties of the product or require expensive equipment which is not commonly available at regional offices, and therefore the product is often shipped to remote suppliers or manufacturing plants for refurbishment. As such, the teaching of the present disclosure allows local application of a thermosetting polymer coating without investment in expensive equipment or lost time due to shipping to a remote location having specialized equipment.

Another advantage is to provide chemical resistance to bit bodies where salt water, entrained corrosive elements (such as CO2), or other downhole chemicals can cause stress corrosion attack. This chemically resistant coating can be factory applied and locally reapplied during refurbishment at regional sites or in the field.

The advantages can be realized on bit bodies where chemical attack, cuttings packing (such as on blades of PDC bits), and wear occur. These advantages are also applicable to other non-rock bit downhole equipment (DTH hammer, rotary percussion tools, mud motors, and the like).

A combination of advantageous properties can be achieved through combination of coating properties, and blending of one or more additives to achieve one or more of the above mentioned improvements.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a perspective view of a PDC drill bit with certain external surfaces coated with a thermosetting polymer coating with an optional infused additive material according to the teachings of the present disclosure;

FIG. 2 is a schematic illustration of the application of a thermosetting polymer coating to a surface of the PDC bit of FIG. 1;

FIG. 3 is a schematic illustration of the application of a thermosetting polymer coating with an infused additive material to an external surface of the PDC bit of FIG. 1;

FIG. 4 is a schematic illustration of an alternate embodiment of the application of a thermosetting polymer coating with an infused additive material to an external surface of the PDC bit of FIG. 1;

FIG. 5 is a schematic illustration of an additional alternative embodiment of the application of a thermosetting polymer coating with an infused additive material to an external surface of the PDC bit of FIG. 1;

FIGS. 6A-6B are schematic illustrations of an alternative embodiment of the application of a thermosetting polymer coating with an infused additive material to an external surface of the PDC bit of FIG. 1;

FIG. 7 is a perspective view of a rotary cone drill bit with a thermosetting polymer coating with optionally infused additive material applied to certain external surfaces of the bit including certain non-cutting external surfaces of the roller cone cutters;

FIG. 8 is a perspective view of a milled tooth rotary cone drill bit with a thermosetting polymer coating with optionally infused additive material applied to certain external surfaces of the bit including certain non-cutting external surfaces of the roller cone cutters;

FIG. 9 is a plan view of a face of a down-the-hole hammer bit with a thermosetting polymer coating with optionally infused additive material applied to certain external surfaces of the hammer bit;

FIG. 10 is a perspective view of a stabilizer with a thermosetting polymer coating with optionally infused additive material applied to certain external surfaces of the stabilizer; and

FIG. 11 is an elevation view of a blade of a snowplow with a thermosetting polymer coating with optionally infused additive material applied to certain external surfaces of the blade according to the teachings of the present disclosure.

### DETAILED DESCRIPTION

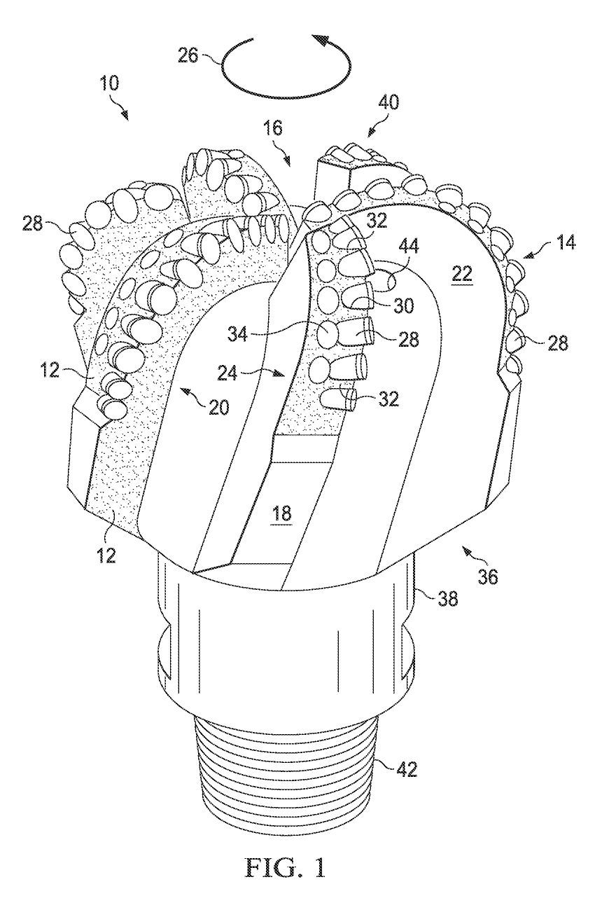

Reference is now made to FIG. 1, which shows a perspective view of an earth boring drill bit 10 with a thermoset coating 12 applied to particular external surfaces. The thermoset coating 12 is selected and applied to increase the bit's resistance to wear, resistance to chemical erosion, and its resistance to cutting material build-up on the bit, also referred to as balling. The drill bit 10 comprises a plurality of blades 14. One blade is separated from an adjacent blade 14 by a junk slot 16. The blades 14 extend radially from a central rotational axis to define the gage 18 of the bit. The blades include a leading face 20, a backside 22 opposite the leading face 20, and a top surface 24. The leading face 20 faces the rotation direction 26 of the bit 10.

Each blade supports a plurality of cutting elements 28, also referred to as cutters. A cutter pocket 30 is formed in the top surface 24 of the blades 14. A cutting element 28 is brazed or otherwise secured in the cutter pocket 30. The cutting element 28 may be any suitable type of cutting element. For example, the cutting elements 28 illustrated in FIG. 1 are polycrystalline diamond compact (“PDC”) cutters. In turn, the bit 10 may be referred to as a PDC bit. The bit 10 may also be referred to as a fixed-cutter or a drag bit. Each cutter 14 may have its superabrasive surface facing the rotational direction 26 of the bit to facilitate drilling as the bit 10 rotates into the earth. A web portion 32 of the top surface 24 of the blade is disposed between adjacent cutting structures 28. According to certain embodiments, a backup structure 34 may be secured the blade 14 proximate the cutting structures 28. The backup structures 34 help reduce erosion of the top surface 24 that is likely to lead to loss of a cutting element 28, and therefore reduced performance of the drill bit 10.

A body 36 of the bit includes a shank 38 and a bit face 40, which includes the blades 14. The illustrated embodiment includes six blades 14; however, any suitable number of blades may make up the face 40. Threads 42 are formed in the shank 38 to allow the bit 10 to be attached to a drill string and rotated to break apart earth and create a borehole. A drilling fluid channel is disposed internal to the bit body. Drilling fluid is pumped from the surface through the drill string and through a drill fluid conduit 44 formed in the junk slot 16. The primary purpose of the drilling fluid is to direct cuttings that the bit has separated and broke apart from the earth up the borehole to the earth surface.

As stated above, the cutters 28 are brazed into respective cutter pockets 30 in the metal substrate making up the body of the bit 10. The bit substrate may be formed from steel, a matrix metal, or any other material suitable for earth boring drill bits. The matrix metal may include tungsten carbide and a suitable binder material. The tungsten carbide may be a powder braze or infiltrated with a braze filler metal, which may comprise manganese, nickel, zinc, and/or copper.

During earth boring operations, portions of the substrate may erode causing the cutters 14 to become loose in the pockets, which may lead to loss of cutters. It is an object of the present disclosure to provide certain surfaces of the bit with a robust and tenacious thermoset coating 12. According to certain embodiment, the thermoset coating 12 may be infused with a hard material to strengthen the thermoset coating, for example, when additional wear resistance is desired.

According to certain embodiments, before the thermoset coating 12 is applied to the surfaces of the bit 10, a displacement, also referred to as a displacement plug, may be positioned in the cutter pocket as a location tool or locator. The displacement maintains the pocket as the thermoset coating 12 is applied to the surfaces of the bit. The displacement is typically a plug formed from a graphite material, a silicate material, a ceramic material, or any other suitable material. Generally, the thermoset coating 12 is applied in a heated, spray application, as described in more detail below. According to the illustrated embodiment of the PDC bit 10, the thermoset coating 12 is applied to the leading face 20 and the top surface 24 including the web portion 32 proximate the cutting elements 28. The thermoset coating is not typically applied to the junk slots 16 and the gage 18 of the bit 10. Coating 12 applied proximate the cutting elements 28 may be particularly effective in reducing wear at the surfaces that secure the cutter elements 28. In this manner, retention of cutter elements 28 may be improved by application of the thermosetting polymer coating (with or without one or more additives) according to the teaching of the present disclosure.

The thermosetting polymer may be applied to other types of earth boring drill bits, such as roller cone bits having cutter inserts and/or machined teeth, down-the-hole tools, such as a hammer bit, or a steel or matrix body stabilizer or reamer, frac plug drill bit, casing bit, and the like. The substrate of the earth boring bits and other tools may be formed from steel, a matrix metal, or any other material suitable for earth boring drill bits. The matrix metal may include tungsten carbide. The tungsten carbide may be a powder brazed or infiltrated with a braze filler metal, which may comprise manganese, nickel, zinc, and/or copper. Other components or tools used in earth boring operations may also be provided with a thermosetting polymer coating (with or without infused additives), including those components and surfaces positioned and used in frequent contact with drilling fluid, formation cuttings, formation fluid, high temperatures, and other harsh environmental elements, such as packers, plugs, mud motors, rotary percussion tools, and the like.

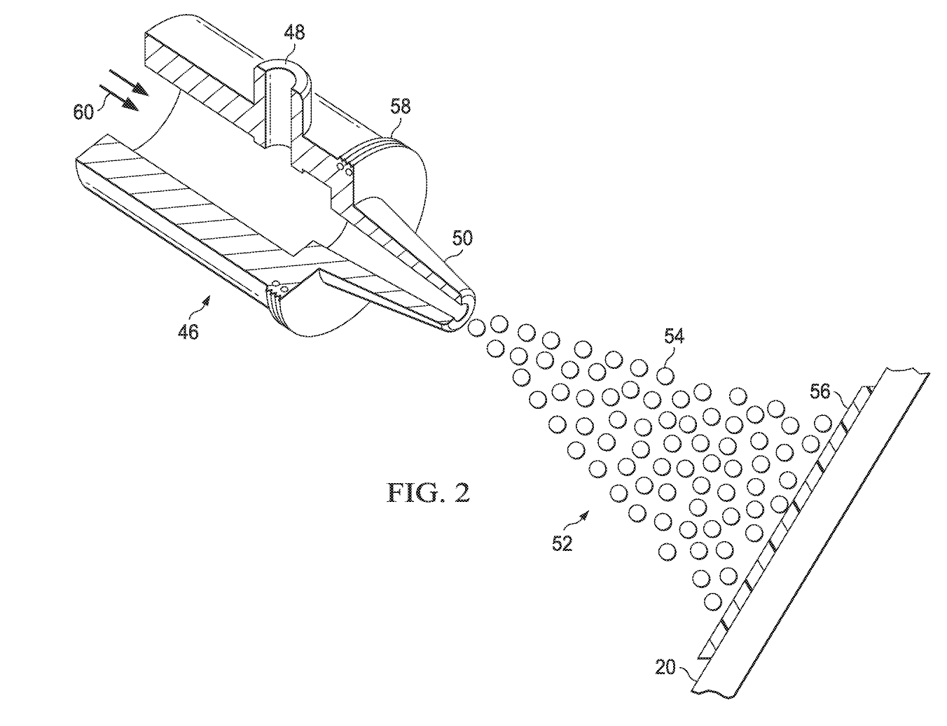

Reference is made to FIG. 2, which is a schematic illustration of the heated spray application of a thermoset coating to an external surface of an industrial tool according to the teachings of the present disclosure. FIG. 2 illustrates the spray application of a thermoset material to a portion of a leading face 20 of a blade 14 of the PDC bit of FIG. 1. As described further below, heated spray application of a thermoset material according to the teachings of the present disclosure is not limited to earth boring bits, but rather may include a wide variety of industrial tools that can benefit from increased resistance to wear.

A liquid form of a thermosetting polymer is received by a thermal sprayer 46 through a polymer resin inlet 48. According to an exemplary embodiment, a spray gun has one inlet for receiving a thermosetting polymer resin and a second separate inlet for receiving an iso-hardener. Upon being received by the gun, the two materials are simultaneously sprayed through the nozzle as an atomized resin and hardener mixture. In the illustrated embodiment, the separate resin and iso inlets are represented by the polymer resin inlet 48. The resin and hardener are atomized by the thermal sprayer 46 and the thermosetting polymer resin is propelled from a nozzle 50 as atomized stream 52 of thermosetting polymer resin droplets 54 toward the substrate surface 20 where it forms a thermoset coating 56. The thermal sprayer 46 includes a heating element 58 and propelling energy or media (represented by arrows 60). The thermosetting polymer resin is heated by a heating element 58, which may employ combustible gas, plasma flame, or an electric heating element to heat and melt the thermosetting polymer resin into droplets, which are propelled out of the sprayer 46 by compressed gas. In certain embodiments, the sprayer 46 may be a hand held spray gun, which allows for precise application of the coating to particular surface of the industrial tool. An example thermal spray system 46 is shown and described in U.S. Pat. No. 7,694,893, to Zittel et al., entitled “Plural Component Spray Gun for Fast Setting Materials,” and assigned to Graco Minnesota Inc. (the '893 Patent), which is hereby incorporated by reference. A commercial embodiment of the spray system described by the '893 Patent is a plural component, impingement mix, mechanical purge spray gun available from Graco Inc. of Minneapolis, Minn. under the trade name Fusion.

When the thermosetting polymer resin droplets 54 strike the surface 20 to be coated, they flatten, flow, and meld into adjacent particles to form a continuous film. The film coats the surface 20, providing the thermoset coating 56. Thermosetting polymers irreversibly cure to form a tenacious (strongly bonded) and flexible coating. According to certain embodiments, the coating cures at low temperatures, such that only a heated spray is required and there is no additional heating to the surface of the bit required for the thermosetting polymer to bond thereto.

The tenacious thermoset coating 56 will reliably cure in ambient temperature and bond to the metallic surfaces of the bit, without a high temperature baking cycle (approximately 500 degrees Fahrenheit or higher). The flexibility of the coating allows it to be applied onto different surface geometries without experiencing the flexing crack after it is cured. The coating 56 can be selected for additional properties, such as abrasion resistance, temperature and chemical resistance to the downhole environment, or resistance to bonding to drilling mud/rock particles (commonly called mud packing or bit balling). The coating thickness has a wide range of controllability (0.001-0.150 inches), which is suitable for tolerance/clearance consideration in earth boring bit design.

In the embodiment illustrated by FIG. 2, only the thermosetting polymer resin, without an additive is applied as the thermoset coating 56 to the surface 20. The resin cures approximately simultaneously with contacting the surface 20 and the curing forms a bond with the surface 20. The propelling media 60 may generally be compressed air, but other types of propelling media or energy may be used according to the teaching of the present disclosure. Curing may occur as a result of a reaction of a resin with a hardener. In certain embodiments, the thermoset coating 56 may include a polyurethane resin, a color component, and an iso-hardener. When the thermoset coating 56 is cured, it toughens or hardens due to cross-linking polymer chains in the thermosetting polymer resin 48. The curing process transforms the resin 48 into a hardened or solid thermoset. The solid material forms because during the reaction, the molecular weight increases such that the melting point of the thermoset coating 56 is higher than the surrounding ambient temperature. When the thermoset coating 56 is applied as fluid droplets 54 to the metallic surface 20, the two materials are in direct contact with each other and a strong bond is formed directly between the thermoset coating 56 and the metallic material of the substrate surface 20 when the thermoset coating 56 cures. This bond may be much stronger than a bond formed by applying glue or another type of adhesive to adhere the coating to the metallic substrate.

The thermosetting polymer resin may include Polyurea, Bis-maleimides (BMI), Epoxy (Epoxide), Phenolic (PF), Melamine formaldehyde, Polyester, Polymide, Polyurethane, Urea-formaldehyde, Epoxy novolac, Polysiloxanes (Silicone), vulcanized rubber, and any combination of one or more of such materials. According to one embodiment, a polyurea resin is applied to certain high wear areas of an industrial tool, such as an earth boring drill bit. According to an alternate embodiment, a hybrid thermosetting polymer forms the base of a coating resin. The hybrid thermosetting polymer may be a polymer resin, for example Polyhedral oligomeric silsesquioxane (“POSS”) molecules.

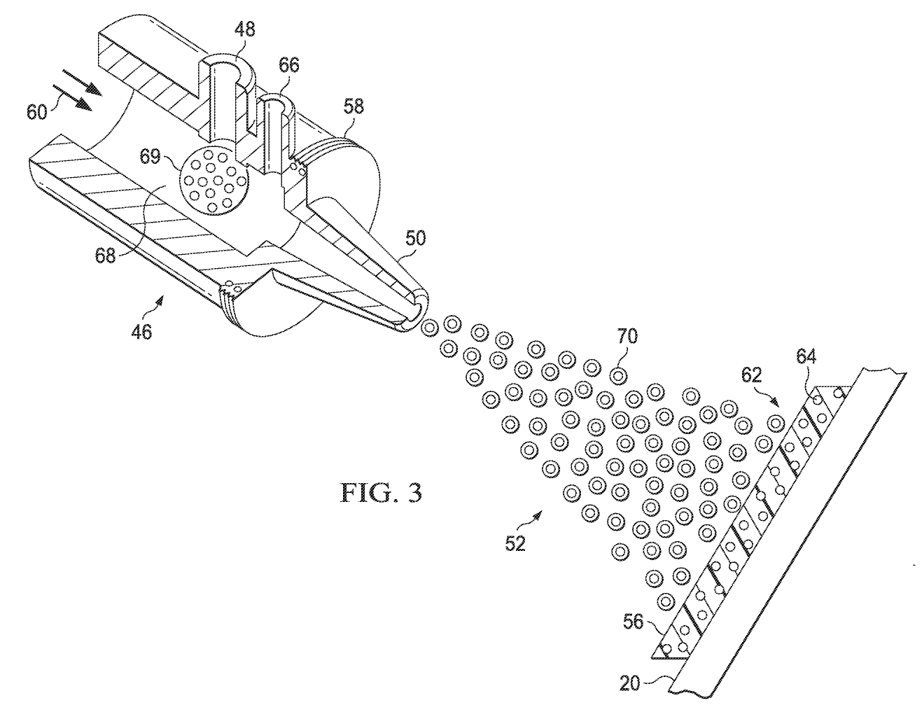

Reference is now made to FIG. 3, which is a schematic illustration of an alternate embodiment of a heated spray application of a thermoset coating to an external surface of an industrial tool, such as the leading face 20 of the blade 14 of the PDC bit of FIG. 1. FIG. 3 illustrates the application of an additive infused thermoset coating 62. The thermosetting polymer resin described above with respect to FIG. 2 is infused with an additive 64 in a particulate-type form, such as a hard material that has a greater resistance to wear (mechanical or chemical) than the thermoset coating 56 alone.

In this embodiment, the thermosetting polymer resin is supplied to the thermal polymer sprayer 46 through the polymer resin inlet 48, and the additive 64 is supplied through a separate additive inlet 66. The thermosetting polymer resin mixes with the additive in a chamber 68 of the thermal spraying system 46 to form an additive infused premix material 69 that can then be sprayed through the nozzle 50. The mixing may occur either before or simultaneously with heating of the polymer by the heating element 58. In this embodiment, the atomized spray 52 includes additive infused droplets 70. The atomized spray 52 is deposited on the surface 20 of the where the thermosetting polymer resin cures to create an additive infused thermoset coating 62 that includes the additive particles 64 distributed within the thermoset coating 56.

The additive material 64 is selected to improve certain properties of the coated portions of the surface 20. The additive material may be selected to resist abrasive wear and/or resist chemical attack of the external surface 20 from chemicals in the drilling fluid. In addition, the additive material 64 may be selected to reduce formation packing onto a cutting structure, such as the blades 14 of the PDC bit 10 shown in FIG. 1. This formation packing phenomenon is also referred to as “balling.” The additive material 64 may be a family of hard, wear resistant particles; such as tungsten carbide, ceramic, polycrystalline diamond, natural diamond, cubic boron nitride (CBN), and the like. Additional or alternative additive materials may include alumina, carbon black, silica, silicate, calcium carbonate, magnesium carbonate, kaolin, dolomite, chalk, feldspars, mica, barium sulfate, or a combination thereof. The weight %, size distribution, and combinations of the above additive materials 64 in various proportions may vary and may be selected to improve the desired surface properties of the coated surface.

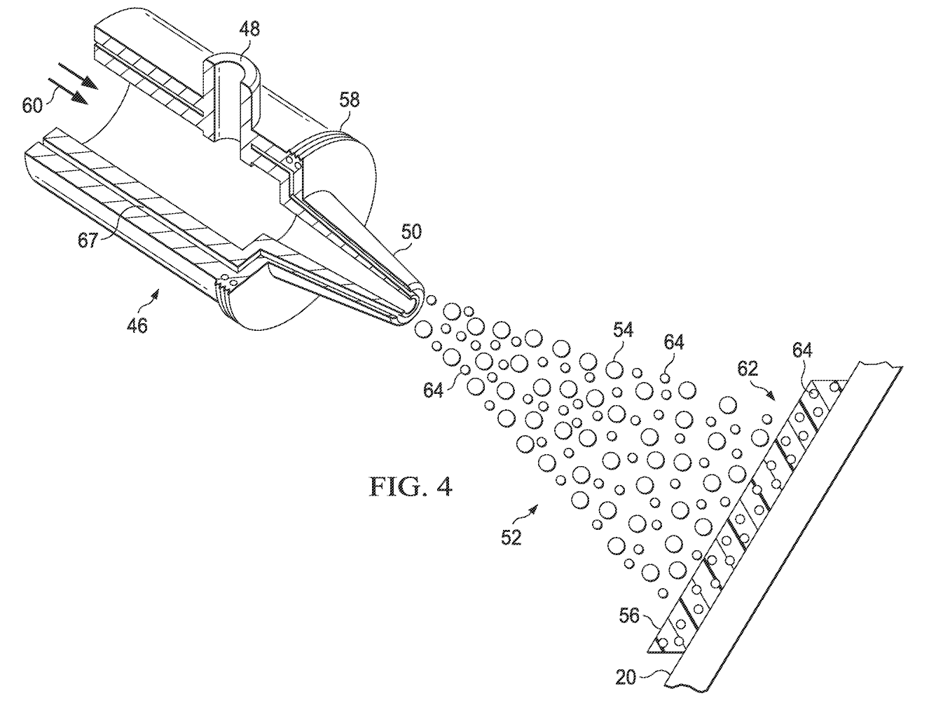

FIG. 4 is a schematic illustration of an alternate embodiment of a system for coating the surface 20 with an additive infused thermosetting polymer coating 62. In this embodiment, the thermosetting polymer resin and the additive material are separately supplied to the thermal polymer sprayer 46, and the additive material 64 is propelled from the spray system separately from the thermosetting polymer resin droplets 54. The additive material is delivered by an additive material conduit 67 to the nozzle 50. The same or a different propelling energy or media 60 may be used to propel the additive material 64 as is used to propel the thermosetting polymer 54. In this embodiment, the atomized spray stream 52 includes both thermosetting polymer resin droplets 54 and additive material 64, which infuses with the thermosetting polymer simultaneously with being deposited on the surface 20. The resulting additive infused thermosetting polymer coating 62 includes additive material 64 distributed within a layer of cured thermosetting polymer coating 56.

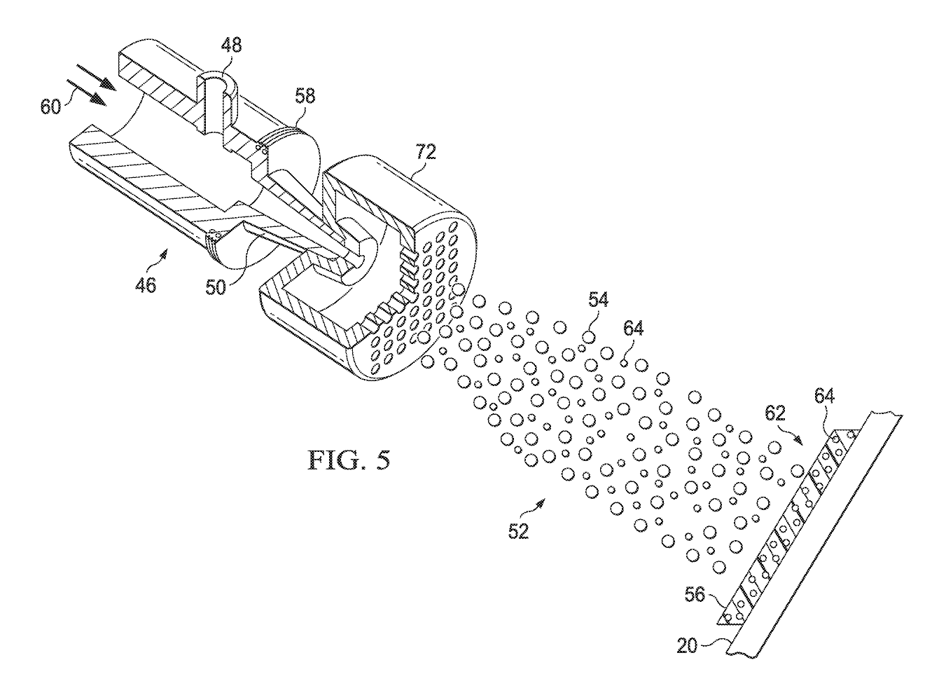

FIG. 5 illustrates an additional embodiment of an additive infused thermosetting polymer spray system according to the teaching of the present disclosure. The thermosetting polymer resin is supplied through an inlet 48 to the thermal sprayer 46 including the propelling energy or media 60 and the heating element 58. An additive cartridge 72 is disposed in the spray path near the nozzle 50. The thermosetting polymer resin droplets 54 separate and propel small particles of additive material 64 from the cartridge 72. The additive material 64 is carried in the atomized stream 52 and deposited on the surface 20. According to this embodiment, the thermosetting polymer and the additive may partially mix during travel from the sprayer to the surface 20 to be coated. However, most of the additive material 64 is propelled and carried by the atomized spray stream 52 to be deposited on the surface 20. The additive infused thermosetting polymer 62 cures and bonds to the surface 20 to create a coating to improve certain surface properties of the coated surface. The resulting additive infused thermosetting polymer coating 62 includes additive material 64 distributed within a layer of cured thermosetting polymer coating 56.

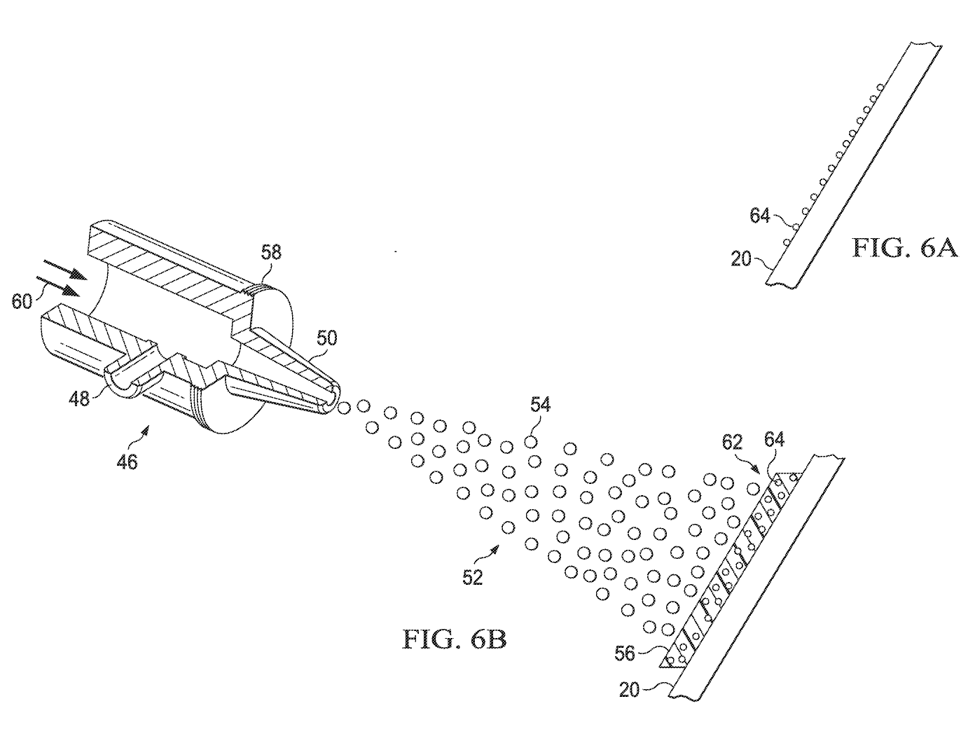

FIGS. 6A and 6B schematically illustrate an additional embodiment of a spray system for forming an additive infused thermosetting polymer coating 62 on the surface 20. In this embodiment, the additive material 64 is pre-applied to the surface 20. A binder is used to loosely adhere the additive 64 to the surface 20 such that it is in position to be covered and coalesced with the thermosetting polymer resin droplets 54. The additive may be separately sprayed, brushed, or poured on the surface, or other suitable application method for loosely adhering particles of hard material to a metal or matrix surface. The resulting additive infused thermosetting polymer coating 62 includes additive material 64 distributed within a layer of cured thermosetting polymer coating 56.

Alternate embodiments of the present disclosure contemplate application of a coating including a thermosetting polymer and optionally an additive by plasma coating (PECVD-plasma enhanced chemical vapor deposition), physical vapor deposition (“PVD”), and the like.

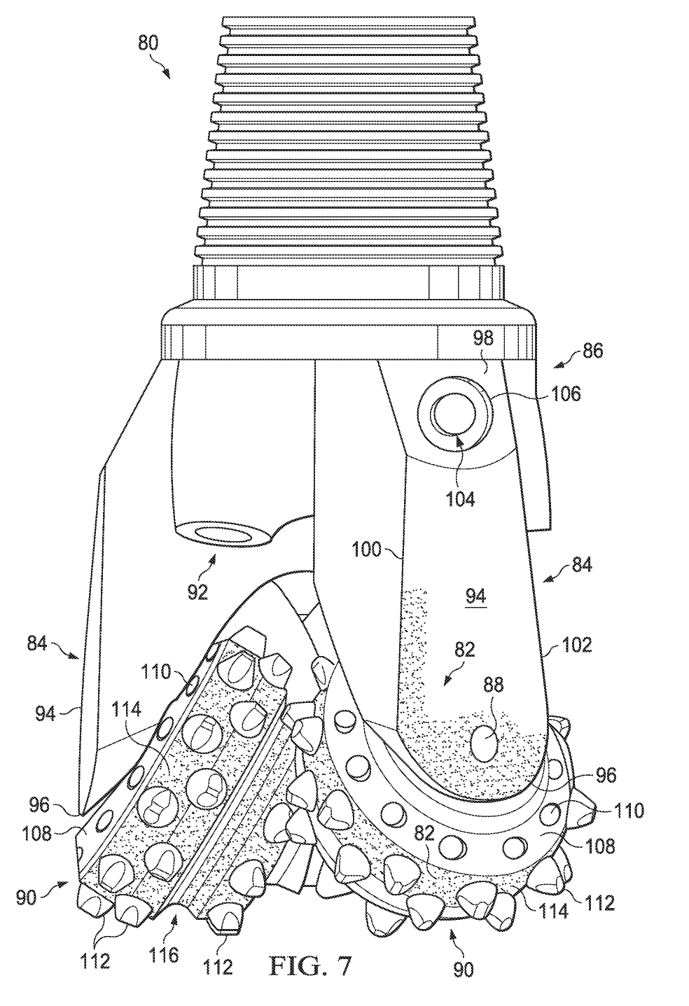

FIG. 7 illustrates a perspective view of a rotary cone drill bit 80 with a thermoset coating 82 applied to external surfaces of the bit 80 as described above with respect to FIG. 2. In an alternate embodiment, the thermoset coating is infused with an additive material and applied as described above with respect to FIGS. 3-6B. Three legs 84 depend from a body portion 86 of the drill bit 80. A weld 88 marks a location on the leg 84 where a pin is joined to the leg 84. The pin extends in a downward and radially inward direction from each leg 84 and supports a rotatable roller cutter cone 90. Drilling fluid is pumped through an internal plenum and through one or more drill fluid nozzles 92 to direct cuttings away from the bit 80 and up the borehole.

An outer surface 94 of the leg 84 terminates at a semicircular edge 96 proximal to the cone 90. The region of the leg 84 associated with the surface 94 is known in the art as the “shirttail region,” and the edge 96 is known in the art as the “shirttail edge.” The shirttail edge 96 is provided where the terminal portion of the outer gage or shirttail surface 94 transitions to an inside radial surface oriented parallel to the base of the cone 90. The outer surface 94 of the leg 84 (below shoulder surface 98) in the shirttail region laterally terminates at a leading shirttail edge 100 and a trailing shirttail edge 102. The leading shirttail edge 100 is especially susceptible to wear during operation of the rotary cone drill bit 80.

A lubrication system provides lubricant (such as grease) to lubricate internal bearing and seal surfaces that facilitate rotation of the cone 90 on the pin. The lubrication system includes a pressure compensation assembly 104 installed within an opening 106 formed in an upper shoulder surface 98 of the leg 12.

Each roller cutter cone 90 includes a heel surface 108 that is adapted to retain heel cutter elements 110 that scrape or ream the sidewall of the borehole as the cutter cones cutters 90 rotate in the borehole. Each rolling cone cutter 90 defines a generally conical surface with the tip or nose of the cone being generally toward the center of the bit 80. The generally conical surface is adapted to support, among other features, primary cutter elements 112 that gouge or crush the borehole bottom as the rolling cone cutters 90 rotate about the borehole. The generally conical surface includes a plurality of ridges referred to as lands 114. Cutter pockets are formed in the lands 114, and a cutter element 112 insert is secured, typically brazed, into the cutter pocket. The cutter inserts 112 are chisel-shaped but may be conical-shaped, dome-shaped, double conical-shaped, ovoid-shaped, or any other shape suitable for drilling a borehole or drilling through certain equipment in a borehole, such as a casing plug.

Grooves 116 are also formed in generally conical cone surface between adjacent lands 114. The grooves 116 accommodate the cutter inserts 112 of adjacent rotating cones 90 to allow intermeshing of the cutter elements 112. Intermeshing allows the rolling cone cutters 90 to have a larger diameter in order to accommodate the maximum possible pin (journal bearing) size.

A thermosetting polymer coating 82 is applied to specific external surfaces of the bit 80 including certain external surfaces of the cutter cones 90. The thermosetting polymer coating 82 is applied to one or more external surfaces of the legs 84. For example, the coating 82 is applied to the external leg surface 94 at the shirttail region of the bit 80. Also, a thermosetting polymer coating 82 is applied to the external surface 94 of the leg 84 proximate the leading edge 100. The thermosetting polymer coating 82 optionally includes an infused additive material. The coating 82 resists wear and decreases erosion of the external surfaces to which it is applied, which in turn increases bit life. According to certain embodiments, the coating is applied proximate the weld 88 but not directly to the weld 88.

The thermosetting polymer coating 82 with optional infused additive material is applied to the external surfaces of the lands 114 of the cutter cones 90 and also to the external surfaces forming the grooves 116. Thermosetting polymer coating 82 applied to these surfaces of the cones 90 reduces wear and decreases erosion to the surfaces to which the coating 82 is applied. The coating 82 applied to the cones 90 decreases erosion in areas where such erosion is likely to result in loss of expensive cutter inserts 112 that reduces the overall effectiveness of the drill bit.

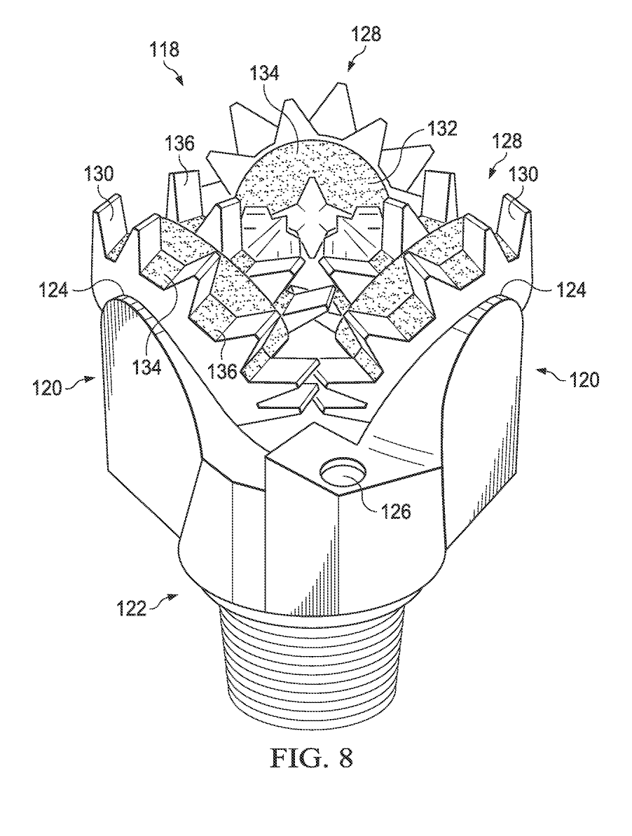

FIG. 8 is a perspective view of a milled tooth drill bit 118. The milled tooth drill bit 118 includes many features similar to the rotary cone drill bit of FIG. 7 including three legs 120 depending from a body 122 that each terminate at a shirttail region 124. Drilling fluid is pumped through one or more drilling fluid nozzles 126. Each leg 120 supports a rotatably mounted cutter cone 128. Teeth 130 are milled into the generally conical surface of the cutter cones 128. The teeth 130 function to break away and crush earth formations as the drill bit 118 rotates to create a borehole. The milled teeth 130 intermesh because an annular relief 132 is formed in the generally conical surface to accommodate the milled teeth 130 of an adjacent cone cutter 128.

A thermosetting polymer coating 134 with optional infused additive material is applied to the external surfaces of the relief 132 of each cutter cone 128. The coating 134 is also applied to a land surface 136 at the base of the milled teeth 130. Generally, a thermoset polymer coating 134 may be applied to any surface of the cutter cones 128 that do not primarily function to break-away, cut, and crush earth and rock formations. Similar to the rotary cone cutter bit of FIG. 7, the thermosetting polymer coating 134 may also be applied to the external surfaces of the legs 120, particularly at the shirttail region or the leading edge of the legs 120. As described above with respect to FIG. 7, the thermosetting polymer coating 134 is optionally infused with an additive material that increases the erosion resistance of the external surfaces of the bit to which it is applied, and thereby increases the useful life of the milled tooth bit 118.

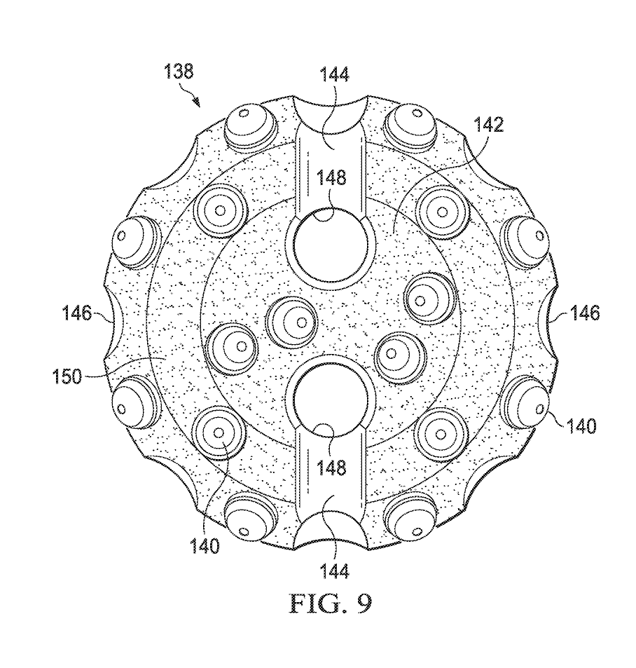

FIG. 9 illustrates a face of a down-the-hole hammer bit 138. A plurality of spherical inserts 140, also referred to as buttons, extend from an external face surface 142 of the bit 138. The face also includes a pair of face grooves 144 extending radially toward the gage of the bit where they each intersect a respective gage groove 146. The gage grooves 146 allow cuttings to be flushed away from the bit 138 an up the borehole. The cuttings are flushed by air from a pair of exhaust orifices 148 respectively disposed within the face grooves 144. According to the teachings of the present disclosure, a thermosetting polymer coating 150 optionally with infused additive material is applied to the external face surface 142 of the hammer bit 138. The thermosetting polymer coating 150 optionally with infused additive material increases the erosion resistance of the external face surface 142 of the hammer bit 138 to which it is applied, and thereby increases the useful life of the hammer bit 138.

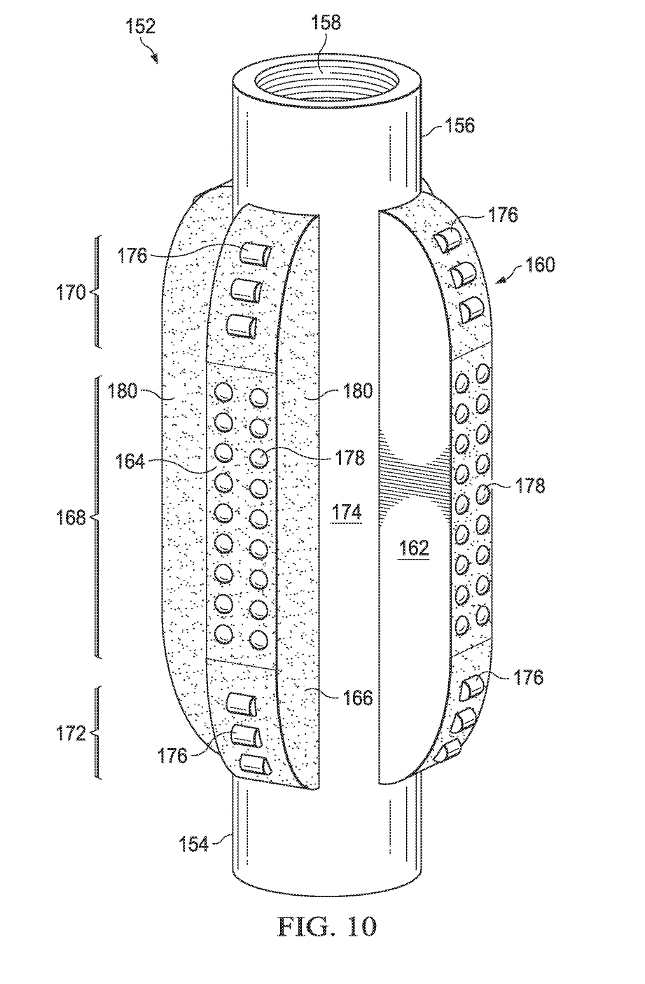

FIG. 10 illustrates a perspective view of a stabilizer 152, which has the dual function of stabilizing a drill string and reaming a borehole. According to certain embodiments, the stabilizer is threadedly coupled at a lower connection end 154 to a drill string above a rotary cone drill bit, and is coupled to the drill string at an upper connection end 156 to a lower portion of the drill string. A bore channel 158 runs through the center of the stabilizer 152. The stabilizer 152 includes a plurality of radially extending blades 160 spaced apart circumferentially. The external surface of the blades 160 includes a leading blade face surface 162, a radially distal blade surface 164, and a trailing blade surface 166. The radially distal blade surface 164 includes a gage section 168, a tapered upper section 170, and a tapered lower section 172. The stabilizer 152 may be axisymmetric or alternately asymmetric. An example of a force balanced asymmetric stabilizer is shown and described in U.S. Pat. No. 8,162,081 to Ballard and entitled “Force Balance Asymmetric Drilling Reamer and Methods for Force Balancing,” which is hereby incorporated by reference. Ballard's stabilizer includes a concave leading blade face 16 and a flat, angled trailing surface 166 of each blade 160. A cylindrical surface 174 between the blades 160 provide a passageway for cuttings to be flushed away from the stabilizer 152 and up the borehole.

The upper tapered section 170 and the lower tapered section 172 support cutter element inserts 176 that are brazed or press-fit into cutter pockets formed in the blade 160. The cutting edge of the cutter elements 176 may be made from hard cutting elements, such as natural or synthetic diamonds. The cutter elements 176 made from synthetic diamonds are generally known as polycrystalline diamond compact cutters (“PDCs”). Other materials, including, but not limited to, cubic boron nitride (CBN) and thermally stable polycrystalline diamond (TSP), may be used for the cutting edge of the cutter elements 176. These cutter elements 176 may be embedded in pockets in the upper tapered section 170 and the lower tapered section 172. The cutter elements 176 may be flat-faced or dome-shaped. Alternatively, the cutter elements 176 may be fabricated from tungsten carbide.

The gage section 168 supports gage inserts 178 that are press fit into pockets formed in the gage section 168. The plurality of gage inserts 178 may be made from low-friction tungsten carbide buttons. Although low-friction tungsten carbide buttons have been illustrated for use as gage inserts 178, other materials used for gage protection, including but not limited to nylon, Teflon posts, and other low-friction inserts, may be used for the gage inserts without departing from the scope and spirit of the exemplary embodiment. Top surfaces of the gage inserts 178 may be flat-faced or dome-shaped. Although the top surfaces of the gage inserts 178 have been described as being flat-faced or dome-shaped, any other shape may be used so that the least amount of torque or cutting action is created against the surface of the wellbore when the force balanced asymmetric drilling stabilizer 152 proceeds through the wellbore.

Additionally, the gage inserts 178 are inserted into the gage section 168 so that the outer edges of the gage inserts 178 are substantially flush with respect to the radially distal blade surface 164 of the gage section 168.

According to the teachings of the present disclosure, a thermosetting polymer coating 180 optionally with infused additive material is applied to external surfaces of the stabilizer 152. In one embodiment, the coating 180 is applied to the upper tapered section 170 and the lower tapered section 172 of the radially extending distal blade surface 164 without being applied to the cutting elements 176. The coating 180 may also be applied to the trailing blade surface 166 of the stabilizer 152. The thermosetting polymer coating 180 optionally with infused additive material increases the erosion resistance of the external surfaces of the stabilizer 152 to which it is applied, and thereby increases the useful life of the stabilizer 152.

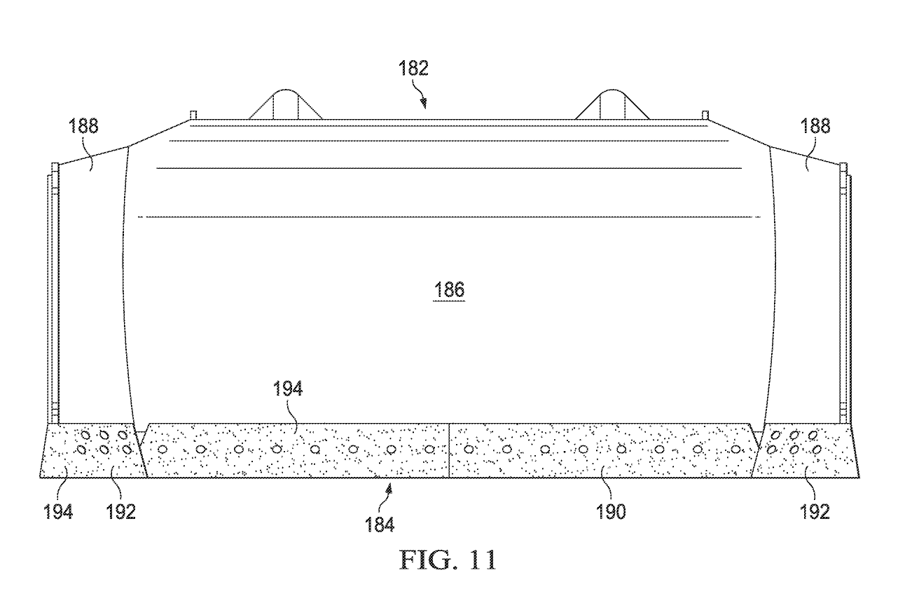

FIG. 11 is an illustration of a blade 182 of a working vehicle. The vehicle may be a tracked vehicle, such as a dozer, or the blade 182 may be secured to an over-the-road vehicle, and function as a snowplow or agricultural plow. The blade 182 is configured to push large quantities of soil, sand, rubble, snow, or other material, earthen or otherwise by operation of the vehicle to which it is attached. An example of a blade similar to the blade 182 is described in U.S. Pat. No. 8,272,451 to Ditzler, entitled “Blade Apparatus with Blade Pitch Adjustability,” which is hereby incorporated by reference.

The blade 182 includes a working, front wall 184 configured to perform the work of the blade 182. The front wall 184 includes a main work plate 186, two side work plates 188 flanking the main work plate 186 and welded thereto, a central cutting plate 190 bolted to a bottom portion of the main work plate 186, and two side cutting plates 192 bolted to respective bottom portions of the side plates 188.

The blade apparatus 182 may be made of conventional or other suitable materials. For example, the cutting plates 190, 192 may be made of hardened, wear-resistant steel. The wear resistance of the cutting plates 190, 192 is increased by the thermoset coating 194 with optionally infused additive material applied as describe above with respect to FIGS. 2-6B. The thermoset coating 194 is applied to the external surfaces of the cutting plates 190, 192. The thermosetting polymer coating 194 with infused additive material increases the erosion resistance (chemical or mechanical) of the working surface of the blade of the vehicle that is subject to wear.

The blade 182 is included as a non-limiting example of an industrial tool coated with a thermoset coating typically infused with an additive material according to the teachings of the present disclosure to increase wear resistance of the tool. Such coating may be applied to other industrial tools that are subject to wear due to abrasion.

Although the foregoing description contains many specifics, these are not to be construed as limiting the scope of the present disclosure, but merely as providing certain embodiments. Similarly, other embodiments of the disclosure may be devised that do not depart from the scope of the present invention. For example, materials and techniques described herein with reference to one embodiment also may be provided in others of the embodiments described herein.

What is claimed is:

1. A method, comprising:
propelling a thermosetting polymer resin as a spray toward a surface of an earth boring tool, the surface exposed to ambient downhole conditions during operation of the earth boring tool;
infusing an additive material with the thermosetting polymer resin; and
coating the surface with an additive infused thermosetting polymer coating comprising the thermosetting polymer resin and the additive material infused therein, the additive infused thermosetting polymer coating curing to form a bond between the coating and the surface.

2. The method of claim 1 wherein the additive material is selected from a group consisting of: tungsten carbide, ceramic material, polycrystalline diamond, natural diamond, and cubic boron nitride.

3. The method of claim 1 wherein the thermosetting polymer resin is selected from a group consisting of: Polyurea, Bis-maleimides, Epoxy, Phenolic, Melamine formaldehyde, Polyester, Polymide, Polyurethane, Urea-formaldehyde, Epoxy Novolac, Polysiloxanes, and vulcanized rubber.

4. The method of claim 1 wherein the thermosetting polymer resin or the additive material is selected to reduce corrosion or pitting of the surface.

5. The method of claim 1 wherein the thermosetting polymer resin or the additive material is selected to reduce stress corrosion cracking or embrittlement of the surface.

6. The method of claim 1 wherein propelling the thermosetting polymer resin further comprises using a thermal sprayer system to heat the thermosetting polymer resin.

7. The method of claim 6, wherein the additive material is premixed with the thermosetting polymer resin in a chamber of the thermal sprayer system.

8. The method of claim 6 wherein the additive material is mixed with the thermosetting polymer resin simultaneously with propelling the thermosetting polymer resin using the thermal sprayer system.

9. The method of claim 6 wherein the additive material is applied to the surface before propelling the thermosetting polymer resin toward the external surface.

10. The method of claim 1 wherein the earth boring tool is a fixed-cutter drill bit and the surface is a leading blade face of a blade of the fixed-cutter drill bit.

11. The method of claim 1 wherein the earth boring tool is a rotary cone drill bit and the surface is a leg of the rotary cone drill bit.

12. The method of claim 1 wherein the earth boring tool is a rotary cone drill bit and the surface is a land of a cutting cone of the rotary cone drill bit.

13. An earth boring tool, comprising:
a substrate having an external surface;
a plurality of cutting elements supported by the substrate; and
a coating comprising a thermosetting polymer covering a portion of the external surface.

14. The earth boring tool of claim 13 wherein the coating has a thickness in a range of 0.001-0.150 inches.

15. The earth boring tool of claim 13 wherein the substrate is a blade of a fixed-cutter drill bit.

16. The earth boring tool of claim 15 wherein the external surface is a top surface of the blade.

17. The earth boring tool of claim 13 wherein the substrate is a land of a roller cone.

18. The earth boring tool of claim 17 wherein the plurality of cutting elements is a plurality of cutter inserts.

19. The earth boring tool of claim 17 wherein a plurality of milled teeth extend from the land.

20. The earth boring tool of claim 13 wherein the substrate is a blade of a stabilizer and the external surface is a radially distal blade surface.

21. The earth boring tool of claim 13 wherein the substrate is a face of a hammer bit.

22. The earth boring tool of claim 13 wherein:
the thermosetting polymer is selected from a group consisting of: Polyurea, Bis-maleimides, Epoxy, Phenolic, Melamine formaldehyde, Polyester, Polymide, Polyurethane, Urea-formaldehyde, Epoxy Novolac, Polysiloxanes, and vulcanized rubber; and
an additive is dispersed within the thermosetting polymer, the additive is selected from a group consisting of: tungsten carbide, ceramic material, polycrystalline diamond, natural diamond, and cubic boron nitride

23. An industrial tool, comprising:
a substrate having an external surface, the external surface susceptible to wear; and
a coating comprising a thermosetting polymer and an additive material covering a portion of the external surface.

24. The industrial tool of claim 23 wherein:
the thermosetting polymer is selected from a group consisting of: Polyurea, Bis-maleimides, Epoxy, Phenolic, Melamine formaldehyde, Polyester, Polymide, Polyurethane, Urea-formaldehyde, Epoxy Novolac, Polysiloxanes, and vulcanized rubber; and
the additive is selected from a group consisting of: tungsten carbide, ceramic material, polycrystalline diamond, natural diamond, and cubic boron nitride.

25. The industrial tool of claim 24 wherein the external surface is a portion of a blade coupled to a working vehicle.
